(19) United States
(12) Patent Application Publication
(10) Pub. No.: US 2026/0267401 A1
(43) Pub. Date: Sep. 10, 2026

(54) INFORMATION PROCESSING APPARATUS, INFORMATION PROCESSING METHOD, AND NON-TRANSITORY COMPUTER-READABLE MEDIUM

(71) Applicant: NEC Corporation, Tokyo (JP)

(72) Inventor: Rui KONDO, Tokyo (JP)

(73) Assignee: NEC Corporation, Tokyo (JP)

(21) Appl. No.: 19/545,213

(22) Filed: Feb. 20, 2026

(30) Foreign Application Priority Data
Mar. 4, 2025 (JP) 2025-033988

(51) Int. Cl. G06F 3/01

(52) U.S. Cl. CPC G06F 3/011

(57) ABSTRACT

An information processing apparatus includes an acquisition unit and an estimation unit. The acquisition unit acquires field-of-view information that is information transmitted from a server to a communication apparatus to provide a service regarding a virtual space to a user, the field-of-view information being capable of estimating an object included in a field of view of the user or an avatar in the virtual space. The estimation unit estimates an effect of the object on the user by using the field-of-view information.

### CROSS-REFERENCE TO RELATED APPLICATION

This application is based upon and claims the benefit of priority from Japanese patent application No. 2025- 033988, filed on Mar. 4, 2025, the disclosure of which is incorporated herein its entirety by reference.

### TECHNICAL FIELD

The present invention relates to an information processing apparatus, an information processing method, and a program.

### BACKGROUND ART

In recent years, use of virtual space has been advancing. In the virtual space, a predetermined object, for example, an advertisement may be displayed. JP 2022-101149 A describes a technique for detecting that a user has browsed an advertisement displayed in a virtual space. Specifically, JP 2022-101149 A describes measuring movement of a line of sight in a case where a subject is acting in a virtual space, determining whether the subject gazes at an advertisement based on the measurement result, and measuring an effect of the advertisement based on the determination result.

### SUMMARY

In order to estimate the effect of the object displayed in the virtual space on the user, it is desirable to be able to acquire information regarding a region included in the field of view of the avatar or the user in the virtual space.

An information processing apparatus according to one aspect of the present disclosure includes

at least one memory storing instructions; and

at least one processor configured to execute the instructions to perform operations including,

acquiring field-of-view information that is information transmitted from a server to a communication apparatus to provide a service regarding a virtual space to a user, the field-of-view information being capable of estimating an object included in a field of view of the user or an avatar in the virtual space, and

estimating an effect of the object on the user by using the field-of-view information.

An information processing method according to one aspect of the present disclosure includes, by a computer,

acquiring field-of-view information that is information transmitted from a server to a communication apparatus to provide a service regarding a virtual space to a user, the field-of-view information being capable of estimating an object included in a field of view of the user or an avatar in the virtual space, and

estimating an effect of the object on the user by using the field-of-view information.

A non-transitory computer-readable medium storing a program according to one aspect of the present disclosure causes a computer to perform operations including,

acquiring field-of-view information that is information transmitted from a server to a communication apparatus to provide a service regarding a virtual space to a user, the field-of-view information being capable of estimating an object included in a field of view of the user or an avatar in the virtual space, and

estimating an effect of the object on the user by using the field-of-view information.

According to an example of the present disclosure, it is possible to acquire information regarding a region included in a field of view of an avatar or a user in a virtual space and estimate an effect of an object on the user.

### BRIEF DESCRIPTION OF THE DRAWINGS

FIG. 1 It is a diagram illustrating an example of a use environment of an information processing apparatus;

FIG. 2 It is a diagram illustrating an example of a functional configuration of an information processing apparatus;

FIG. 3 It is a diagram for explaining an example of processing performed by an estimation unit;

FIG. 4 It is a diagram for explaining an example of processing performed by an estimation unit;

FIG. 5 It is a diagram illustrating an example of a screen displayed on a display of a communication apparatus;

FIGS. 6A and 6B These are diagrams each illustrating an example of a screen displayed on a display of a communication apparatus;

FIG. 7 It is a diagram illustrating a hardware configuration example of an information processing apparatus; and

FIG. 8 It is a flowchart illustrating an example of processing performed by an information processing apparatus.

### EXAMPLE EMBODIMENT

Hereinafter, in the present disclosure, the drawings are associated with one or more example embodiments. In all the drawings, similar components are denoted by similar reference signs, and descriptions thereof will not be repeated as appropriate.

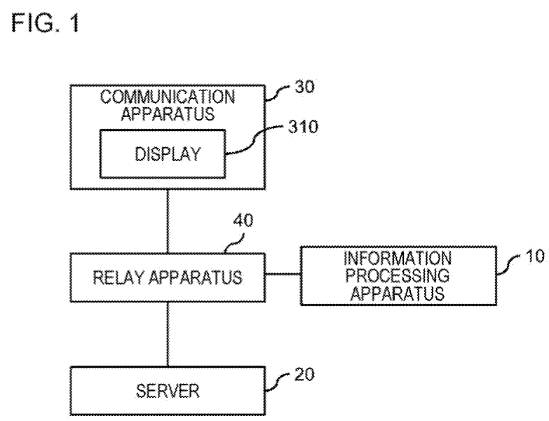

An information processing apparatus 10 is used together with a server 20 and a communication apparatus 30, for example, as illustrated in FIG. 1. The server 20 is an apparatus for providing a service using the virtual space to the user. The communication apparatus 30 is an apparatus operated by a user and includes a display 310. The communication apparatus 30 is, for example, a smartphone, a tablet terminal, a desktop personal computer, or a notebook personal computer. The communication apparatus 30 may include a head-mounted display type device as the display 310. The input for the operation of the communication apparatus 30 may be performed based on at least one operation of a controller, a keyboard, a mouse, a touch of a screen, or a finger detected by a camera.

The avatar of the user exists in the virtual space provided by the server 20. Using at least the position of the avatar in the virtual space, the server 20 generates information necessary for generating a screen to be shown to the user. Hereinafter, this information is referred to as screen generation information. This screen is related to a video showing the scenery in the virtual space obtained with reference to the current position of the avatar, for example, a video showing the scenery in the virtual space from the viewpoint of the avatar or a video showing the field of view of the avatar, and is displayed on the display 310 of the communication apparatus 30. This scenery includes various objects. An example of the object is, but is not limited to, at least one of an advertisement, another avatar, a medium for posting the advertisement (bulletin boards, balloons, buildings, or the like), and a shop or store that sells an item that can be posted in the advertisement. The screen generation information includes, for example, at least one of the coordinates and the orientation of the object in the virtual space and at least one of the coordinates and the orientation of the avatar in the virtual space. Here, the orientation of the avatar includes at least one of the orientation of the avatar's body or face and the line of sight. Then, the server 20 or the communication apparatus 30 uses the screen generation information to generate a screen to be displayed on the display 310. For example, in a case where the communication apparatus 30 generates this screen, the server 20 transmits screen generation information to the communication apparatus 30. Then, the communication apparatus 30 generates a screen using the screen generation information and displays the screen on the display 310.

The user operates the communication apparatus 30 to input operation information for operating the avatar. The operation information includes, for example, information for changing at least one of the position and the orientation of the avatar. The operation information is, for example, at least one of a position operation (frontward, backward, leftward, rightward, in any direction with the stick or cursor tilted, jumping, crouching) and an orientation operation (an operation (for example, up, down, left, and right) for moving the viewpoint in any direction in which the stick or the cursor is tilted, and an operation (for example, up, down, left, and right) for moving the viewpoint in any direction in which the mouse is moved). The communication apparatus 30 transmits the operation information to the server 20. The server 20 updates the screen generation information using the operation information. Then, the server 20 or the communication apparatus 30 updates the screen using the screen generation information.

The communication apparatus 30 may transmit information other than the operation information to the server 20. For example, in a case where the communication apparatus 30 has a function of detecting the line of sight of the user and has a function of specifying a portion, that is, a viewpoint intersecting with the line of sight of the display 310, the communication apparatus 30 may transmit, to the server 20, information indicating the position of the viewpoint of the display 310, to the information processing apparatus 10.

As described above, an object, for example, an advertisement exists in the virtual space provided by the server 20. This object is displayed, for example, at a specific position in the virtual space. However, the object may be moving. For example, in a case where the object is an advertisement, the advertisement may be a non-player character. Then, in a case where the object is displayed to the user, the information processing apparatus 10 performs processing for estimating what effect the object has caused to the user, for example, what value the display has caused. Hereinafter, this processing is referred to as estimation processing.

In this estimation processing, the information processing apparatus 10 acquires at least field-of-view information. The field-of-view information is information transmitted from the server 20 to the communication apparatus 30, and is information from which an object included in the field of view of the user or the avatar in the virtual space can be estimated. The field-of-view information includes, for example, at least one, preferably both, of the coordinates and the orientation of the object in the virtual space, and at least one, preferably both, of the coordinates and the orientation of the avatar in the virtual space. The field-of-view information may include all of the screen generation information described above, or may include only a part of the screen generation information. The field-of-view information may include a screen itself displayed on the communication apparatus 30.

The field-of-view information may include a relative distance from the avatar to at least one object. In a case where the relative distance is included, it is possible to reduce the amount of calculation in a case where the information processing apparatus 10 estimates the object included in the field of view of the avatar. In a case where there are a plurality of objects, the field-of-view information includes the above-described relative distance for each of the plurality of objects. In this way, the overlap between the objects in the field of view of the avatar can be easily calculated.

The information processing apparatus 10 acquires the field-of-view information from the relay apparatus 40, for example. The relay apparatus 40 is located between the server 20 and the communication apparatus 30 on the communication path, and transfers at least part of the field-of-view information, for example, screen generation information, to the information processing apparatus 10. An example of the relay apparatus 40 is a layer 3 switch, but is not limited thereto.

The information processing apparatus 10 acquires at least a part, for example, all of various types of information transmitted from the communication apparatus 30 to the server 20. For example, the information processing apparatus 10 may acquire at least a part, for example, all of the operation information, and further perform the estimation processing using the at least a part of the operation information. The information processing apparatus 10 acquires operation information from the relay apparatus 40, for example. The relay apparatus 40 transfers the operation information to the information processing apparatus 10.

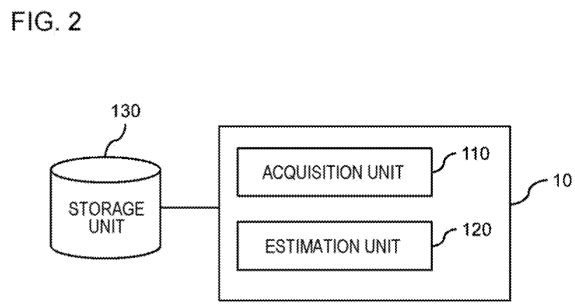

Then, for example, as illustrated in FIG. 2, the information processing apparatus 10 includes an acquisition unit 110 and an estimation unit 120, and can use information stored in the storage unit 130. The storage unit 130 may be a part of the information processing apparatus 10, a part of the server 20, or an apparatus different from these.

The acquisition unit 110 acquires the above-described field-of-view information. The acquisition unit 110 also acquires operation information as necessary.

The estimation unit 120 estimates the effect of the object on the user using the field-of-view information. That is, the estimation unit 120 performs estimation processing. The estimation unit 120 may further perform estimation processing using the operation information.

The various types of information acquired by the acquisition unit 110 may be stored in the storage unit 130, for example. Then, the estimation unit 120 may perform estimation processing using the information stored in the storage unit 130. In this case, the estimation processing may be performed in a batch format.

In this manner, the information processing apparatus 10 acquires the field-of-view information transmitted from the server 20 to the communication apparatus 30, for example, from the relay apparatus 40. Therefore, the information processing apparatus 10 can perform the processing of estimating the effect by the object using the field-of-view information. The information processing apparatus 10 further acquires at least part of the operation information transmitted from the communication apparatus 30 to the server 20 as necessary, and performs estimation processing using this information. In this case, the accuracy of the estimation processing is improved.

Hereinafter, an example of the function of the information processing apparatus 10 will be described in detail.

As described above, the acquisition unit 110 acquires at least one of the field-of-view information, for example, the screen display information.

The acquisition unit 110 also acquires other information necessary for the estimation processing. For example, in a case where the object is an advertisement, this information is an attribute of the advertisement. The attribute of the advertisement is, for example, at least one of the following. Then, the estimation unit 120 corrects the effect of the advertisement using this attribute as described below.

Presence or absence of characters. For example, in a case where there are characters, the estimation unit 120 estimates that the effect of the object is large, and increases the effect.

In a case where there are characters, their sizes. For example, in a case where the characters are large, the estimation unit 120 estimates that the effect of the object is large, and increases the effect.

Two-dimensional or three-dimensional. For example, in the case of three dimensions, the estimation unit 120 estimates that the effect of the object is larger than that in the case of two dimensions, and increases the effect.

Whether there is movement. For example, in a case where there is movement, the estimation unit 120 estimates that the effect of the object is large, and increases the effect range.

Presence or absence of sound. For example, whether a sound is played in a case where the avatar approaches the advertisement. In a case where there is sound, the estimation unit 120 estimates that the effect of the object is large, and increases the effect.

The above effect is merely an example. For example, depending on the advertisement, the estimation unit 120 may estimate that the effect is larger in a case where characters are eliminated, characters are reduced, characters are made two-dimensional, movement is eliminated, or sound is eliminated, and may make a correction to increase the effect of the advertisement.

As described above, the estimation unit 120 performs estimation processing using the field-of-view information. The estimation unit 120 may further perform estimation processing using the operation information.

For example, the estimation unit 120 specifies an object included in a screen illustrated on the display 310 of the communication apparatus 30 using the field-of-view information.

For example, in a case where the field-of-view information includes the coordinates of the object in the virtual space and the coordinates and orientation of the avatar in the virtual space, the estimation unit 120 specifies a region included in the field of view of the user in the virtual space from the coordinates and orientation of the user in the virtual space. Hereinafter, this region is referred to as a field-of-view region. In this specifying, angle information indicating the field of view of the user may be further used. Then, the estimation unit 120 determines that an object whose coordinates in the virtual space are included in the field-of-view region is included in the screen displayed on the display 310, that is, the object is included in the field of view of the user or the avatar.

The estimation unit 120 may determine that the first object is not included in the field of view of the user or the avatar in a case where, even for an object whose coordinates in the virtual space are included in the field-of-view region (hereinafter, described as a first object), another object exists between the first object and the avatar, and a portion of the first object in a predetermined range or more, for example, a portion of 50% or more is shielded by the other object on the screen displayed on the display 310.

In a case where the field-of-view information further includes the orientation of the object, the estimation unit 120 may further use the orientation of the object to specify the object included in the screen illustrated in the display 310. For example, in a case where the front direction of the object is determined and the angle formed by the front direction and the line connecting the center of the object and the avatar is a predetermined value or more, for example, 45° or more, the estimation unit 120 may determine that the first object is not included in the field of view of the user or the avatar. On the other hand, in a case where the angle formed by the line connecting the center of the object and the avatar is less than a predetermined value, for example, less than 45°, the estimation unit 120 may determine that the first object is included in the field of view of the user or the avatar.

Even in a case where an object whose coordinates in the virtual space are included in the field-of-view region is included in the screen displayed on the display 310, in a case where the region of the screen displayed on the display 310 is less than a predetermined area, for example, less than 1/4, the estimation unit 120 may determine that the first object is not included in the field of view of the user or the avatar. On the other hand, in a case where the region of the screen displayed on the display 310 is a predetermined area or more, for example, 1/4 or more, the estimation unit 120 may determine that the first object is included in the field of view of the user or the avatar.

The estimation unit 120 may further specify an object included in the screen illustrated in the display 310 by using the operation information. For example, the estimation unit 120 acquires information indicating a change in the position of the avatar and information indicating a change in the orientation of the avatar from the time point at which the virtual space is accessed to the current time point. In a case where the virtual space is one in which an initial position is defined, the estimation unit 120 adds information regarding the change in the position up to the current point of time to the initial position, that is, the position at the time of entering the virtual space, and adds information regarding the change in the orientation up to the current point of time to the orientation of the avatar at the initial position, so that it is possible to specify at which position and at which angle the user exists thereafter. By using this result, in a case where it can be recognized that an object is included in the screen illustrated in the display 310, the estimation unit 120 can specify that the object is included.

In a case where the field-of-view information includes the screen itself displayed on the display 310, the estimation unit 120 may detect an object displayed on the screen by using an image recognition technology, and determine that the detected object is included in the field of view of the user or the avatar.

Then, for an object included in the user's field of view, the estimation unit 120 executes estimation processing of estimating an effect of the object on the user. In this estimation processing, the estimation unit 120 generates, for example, a value indicating an estimation result of the magnitude of the effect of the object. Hereinafter, this value is referred to as an estimation value.

For example, the estimation unit 120 obtains a distance between the avatar and the object in the virtual space, and increases the estimation value as the distance decreases. At this time, in a case where the distance is equal to or more than the reference value, the estimation unit 120 may determine that there is no effect of the object on the user and set the estimation value to 0. The estimation unit 120 may increase the estimation value as the angle formed by the orientation or the line of sight of the avatar and the line perpendicular to the front face of the object decreases.

In a case where the communication apparatus 30 transmits information indicating the position of the viewpoint of the user or the avatar on the display 310 to the server 20, the acquisition unit 110 may also acquire this information via the relay apparatus 40. Then, the estimation unit 120 may increase the estimation value in a case where this position overlaps with the object, and may decrease the estimation value in a case where this position is away from the object. Here, the estimation unit 120 may decrease the estimation value as the position of the viewpoint moves away from the object.

The estimation unit 120 may further use reaction information indicating a reaction of the user to the object in a case of estimating the above-described effect.

For example, the estimation unit 120 generates reaction information using behavior information indicating the behavior of the avatar in the virtual space. This behavior information includes, for example, history information of the position and orientation of the avatar in the virtual space. The history information is stored in the storage unit 130, for example. Using this history information, the estimation unit 120 can generate, for example, a change in at least one of the relative position and the relative orientation of the avatar with respect to the object, and use the change as at least a part of the reaction information.

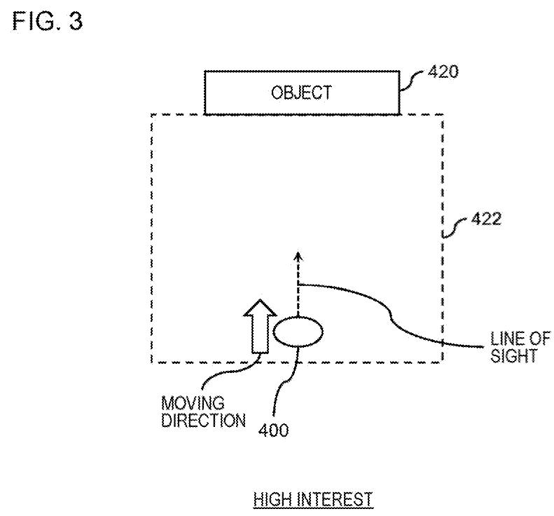

For example, as illustrated in FIG. 3, in a case where the avatar 400 moves in a direction of approaching the object 420, the estimation unit 120 increases the estimation value indicating the effect of the object on the user. Here, in a case where the speed at which the avatar 400 approaches the object 420 is large, the estimation unit 120 may further increase the estimation value.

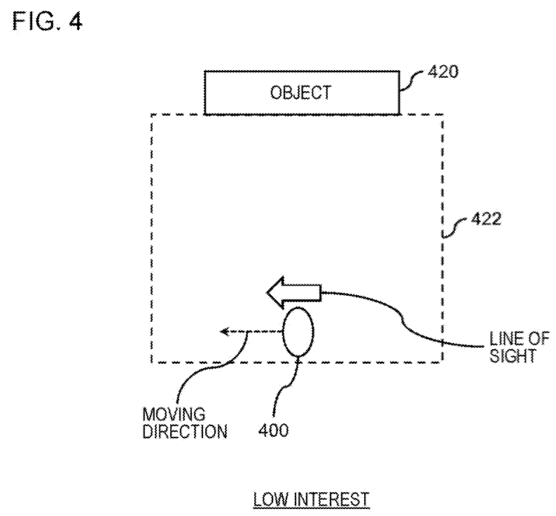

For example, as illustrated in FIG. 4, in a case where the avatar 400 moves in a direction deviating from the front of the object 420, the estimation unit 120 decreases the above-described estimation value.

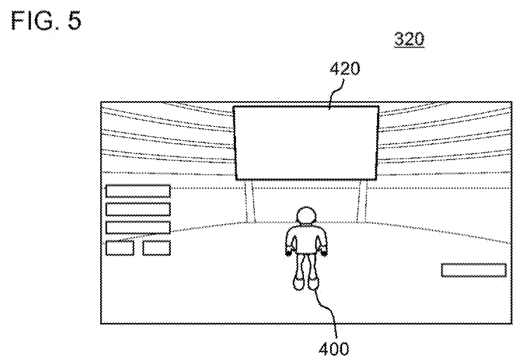

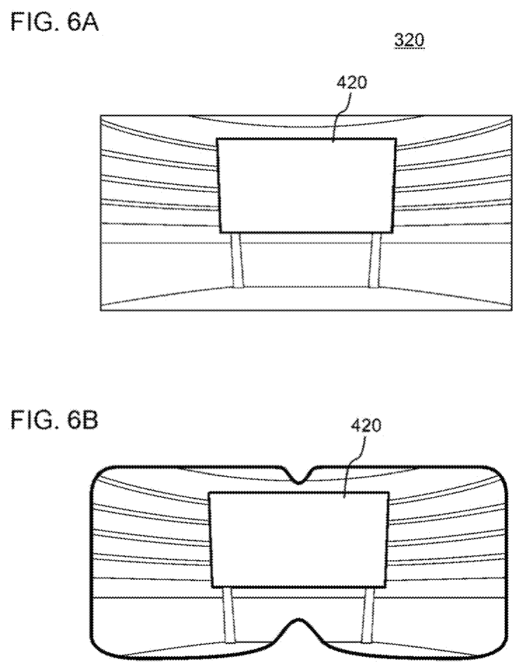

As described above, the screen to be shown to the user is displayed on the display 310. This screen may display a screen in a case where the virtual space is viewed from the viewpoint of the third party, for example, as illustrated in FIG. 5, or may display a screen in a case where the virtual space is viewed from the viewpoint of the avatar, as illustrated in FIGS. 6A and 6B. In these examples, the estimation unit 120 may further calculate the above-described estimation value using the display mode of the object on this screen. The display mode here is, for example, the orientation in which the advertisement is displayed, the size of the advertisement, and the display position of the advertisement.

An example of the information indicating the orientation in which the advertisement is displayed is information indicating the direction in which the advertisement is directed on the screen displayed on the display 310 in the virtual space. For example, the estimation unit 120 increases the estimation value as the orientation of the advertisement approaches the front.

The estimation unit 120 increases the estimation value as the advertisement displayed on the screen displayed on the display 310 increases, that is, as the proportion occupied by the advertisement on the screen increases. In a case where an advertisement is displayed at the center of the display 310, the estimation unit 120 increases the above-described estimation value as compared with a case where an advertisement is displayed at the end of the display 310.

In a state where the object exists in the field of view of the user or the avatar, the estimation unit 120 determines that the effect by the object is large in a case where the reaction of the avatar is favorable, and determines that the effect is small in a case where the reaction is negative.

For example, in a case where the operation information transmitted from the communication apparatus 30 to the server 20 includes causing the avatar to perform a specific reaction, for example, emote, the estimation unit 120 determines whether the reaction is favorable or negative. Then, in a case where the reaction is favorable, the estimation unit 120 increases the estimation value indicating the magnitude of the effect. An example of this processing is to add a specific value to an estimation value generated by another criterion or to multiply the estimation value by a coefficient greater than 1. On the other hand, in a case where the reaction indicates negative, the estimation unit 120 reduces the estimation value. An example of this processing is to subtract a specific value or multiply an estimation value generated by another criterion by a coefficient less than 1. The specific value or coefficient used here can be set by the user of the information processing apparatus 10.

The determination as to whether the reaction is favorable is made using, for example, a database in which information indicating whether the reaction is favorable or negative is associated for each of a plurality of reactions.

The estimation unit 120 may calculate the estimation value using a database indicating scores for each of a plurality of types of representative reactions of the user with respect to the object. This database stores, for example, the following information.

In a case where the object is looked at for a predetermined time or more, a predetermined value is added to the estimation value or the estimation value is multiplied by a coefficient larger than 1.

In the case of approaching the object from a position away from the object by a predetermined distance or more, the estimation value is added to a predetermined value or multiplied by a coefficient larger than 1.

In a case where the avatar 400 makes a favorable emote or comment in a state where the object and the user's viewpoint overlap, a predetermined value is added to the estimation value or a coefficient larger than 1 is multiplied.

In a case where the avatar 400 makes a negative emote or comment in a state where the object and the user's viewpoint overlap, a predetermined value is subtracted from the estimation value or a coefficient of less than 1 is multiplied.

The above-described predetermined value can be set by, for example, a user of the information processing apparatus 10.

In a case where the information input by the user to the communication apparatus 30 includes text information or voice information as an avatar utterance, the estimation unit 120 may generate reaction information using the text information or the voice information.

For example, in a case where the text information or the voice information indicates that the user is favorable to the object, the estimation unit 120 increases the estimation value indicating the magnitude of the effect. An example of this processing is to add a specific value to an estimation value generated by another criterion or to multiply the estimation value by a coefficient greater than 1. The specific value or coefficient used here can be set by the user of the information processing apparatus 10.

On the other hand, in a case where the text information or the voice information indicates that the user is negative for the object, the estimation unit 120 reduces the estimation value. An example of this processing is to subtract a specific value or multiply an estimation value generated by another criterion by a coefficient less than 1. The specific value or coefficient used here can be set by the user of the information processing apparatus 10.

Whether the text information or the voice information is favorable or negative may be determined by, for example, whether a specific keyword is included, or may be determined by using a machine learning model.

In a case where the information transmitted from the communication apparatus 30 to the server 20 includes information indicating the evaluation given to the object by the user (for example, information indicating that the “like button” or the like is selected), the estimation unit 120 may calculate an estimation value indicating the effect of the object on the user by using this information. For example, in a case where the evaluation given to the object is favorable, the estimation unit 120 adds a specific value or multiplies an estimation value generated by another criterion by a coefficient larger than 1. On the other hand, in a case where the evaluation given to the object is negative, the estimation unit 120 subtracts a specific value or multiplies an estimation value generated by another criterion by a coefficient of less than 1. The specific value or coefficient used here can be set by the user of the information processing apparatus 10.

The estimation unit 120 may calculate an estimation value of an effect of an object on a user by using time-series data of a reaction performed by the user or the avatar on a certain object. For example, the estimation unit 120 can specify a change in the avatar’s impression of the object by specifying a difference between a reaction of the user or the avatar in a case where the object is first included in the field of view of the user or the avatar and a reaction of the user or the avatar in a case where the object is subsequently included in the field of view of the user or the avatar. Then, for example, in a case where this change is in a favorable direction, the estimation unit 120 increases the estimation value of the effect of the object on the user. In a case where this change is in the negative direction, the estimation unit 120 reduces the estimation value of the effect of the object on the user.

In a case where the avatar’s impression of the object is continuously favorable, the estimation unit 120 may increase the estimation value of the effect of the object on the user. In a case where the avatar’s impression of the object is continuously negative, the estimation unit 120 may reduce the estimation value of the effect of the object on the user.

In a case where a certain user makes a plurality of reactions to a certain object, the estimation unit 120 may analyze the estimation value for each combination of the plurality of reactions.

In a case where a plurality of objects are arranged close to each other in the virtual space, the estimation unit 120 may specify the influence of the interaction on the reaction of the user. For example, in the virtual space, in a case where the first object A and the second object B are arranged side by side, and the user's line of sight reciprocates a plurality of times between the first object A and the second object B, it is determined that the interaction between the first object A and the second object B is large in the positive direction.

The estimation unit 120 may statistically process the calculated estimation value using the attribute of the user. In this way, the user of the information processing apparatus 10 can determine whether the object is effective for the user having such an attribute.

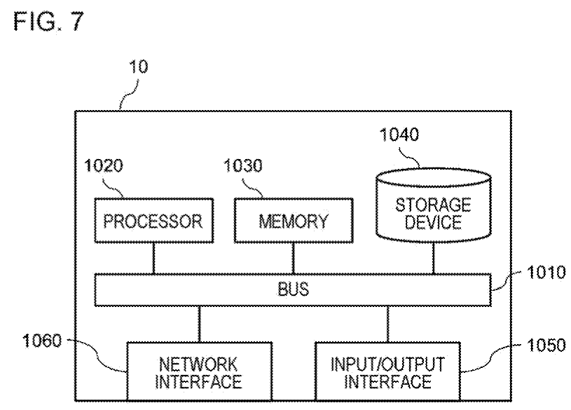

As illustrated in FIG. 7, for example, the information processing apparatus 10 includes a bus 1010, a processor 1020, a memory 1030, a storage device 1040, an input/output interface 1050, and a network interface 1060 as a hardware configuration.

The bus 1010 is a data transmission path for the processor 1020, the memory 1030, the storage device 1040, the input/output interface 1050, and the network interface 1060 to transmit and receive data to and from each other. However, the method for connecting the processor 1020 and other components to each other is not limited to the bus connection.

The processor 1020 is a processor implemented by a central processing unit (CPU), a graphics processing unit (GPU), or the like.

The memory 1030 is a main storage apparatus implemented by a random access memory (RAM) or the like.

The storage device 1040 is an auxiliary storage apparatus implemented by a removable medium such as a hard disk drive (HDD), a solid state drive (SSD), a memory card, or a flash read only memory (FROM), and has a recording medium. The recording medium of the storage device 1040 stores a program module that implements each function (for example, the acquisition unit 110 and the estimation unit 120) of the information processing apparatus 10. Each function relevant to these program modules is implemented by the processor 1020 reading and executing each of the program modules on the memory 1030. The storage device 1040 may further function as the storage unit 130.

The input/output interface 1050 is an interface for connecting the information processing apparatus 10 and various pieces of input/output equipment. For example, the information processing apparatus 10 may communicate with the storage unit 130 via the input/output interface 1050.

The network interface 1060 is an interface for connecting the information processing apparatus 10 to a network. The network is, for example, a local area network (LAN) or a wide area network (WAN). A method for connecting the network interface 1060 to the network may be a wireless connection or a wired connection. The information processing apparatus 10 may communicate with the relay apparatus 40 and the storage unit 130 via the network interface 1060.

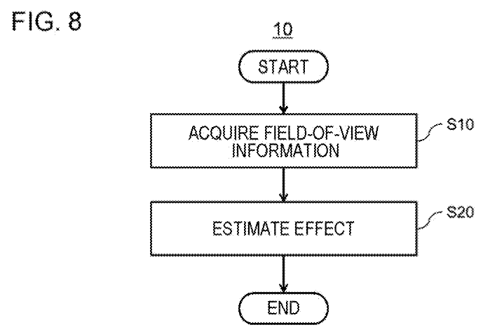

The information processing apparatus 10 performs processing according to the flowchart illustrated in FIG. 8, for example.

First, the user logs in to the virtual space provided by the server 20 via the communication apparatus 30. Thereafter, the server 20 and the communication apparatus 30 continue processing for updating the screen displayed on the display 310 of the communication apparatus 30 while communicating with each other. In this communication, information to be transmitted is via the relay apparatus 40. Then, the relay apparatus 40 transmits at least a part of the information to the information processing apparatus 10. This transmission processing is also called port mirroring.

Then, the acquisition unit 110 of the information processing apparatus 10 acquires the information transmitted from the relay apparatus 40 and stores the information in the storage unit 130, for example. Then, the estimation unit 120 performs the above-described estimation processing in a batch format, and stores the estimation value generated by the estimation processing in the storage unit 130 in association with the object. Here, the estimation unit 120 may further store the attribute information of the user who is the target of the estimation value in the storage unit 130.

As described above, the information processing apparatus 10 acquires the field-of-view information transmitted from the server 20 to the communication apparatus 30, for example, from the relay apparatus 40. Therefore, the information processing apparatus 10 can perform the processing of estimating the effect by the object using the field-of-view information. The information processing apparatus 10 further acquires at least part of the operation information transmitted from the communication apparatus 30 to the server 20 as necessary, and performs estimation processing using this information. In this case, the accuracy of the estimation processing is improved.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the plurality of flowcharts used in the above description, a plurality of steps (processing) are described in order, but the execution order of the steps executed in each example embodiment is not limited to the described order. In each example embodiment, the order of the illustrated steps can be changed as long as nothing interferes in terms of content.

Some or all of the example embodiments described above may also be described as the following Supplementary Notes, but are not limited to the following.

1. An information processing apparatus including:

an acquisition means for acquiring field-of-view information that is information transmitted from a server to a communication apparatus to provide a service regarding a virtual space to a user, the field-of-view information being capable of estimating an object included in a field of view of the user or an avatar in the virtual space; and

an estimation means for estimating an effect of the object on the user by using the field-of-view information.

2. The information processing apparatus according to 1, wherein

the field-of-view information includes at least one of a coordinate and an orientation of the object in the virtual space and at least one of a coordinate and an orientation of the avatar in the virtual space.

3. The information processing apparatus according to 2, wherein

the field-of-view information includes both a coordinate and an orientation of the object, and both a coordinate and an orientation of the avatar.

4. The information processing apparatus according to any one of 1 to 3 above, wherein

the field-of-view information includes a screen displayed on the communication apparatus.

5. The information processing apparatus according to any one of 1 to 4 above, wherein

the acquisition means acquires the field-of-view information from a relay apparatus located between the server and the communication apparatus in a communication path.

6. The information processing apparatus according to any one of 1 to 5 above, wherein

the estimation means further uses reaction information indicating a reaction of the user to the object in a case of estimating the effect.

7. The information processing apparatus according to 6, wherein

the estimation means generates the reaction information using behavior information indicating an action of the avatar in the virtual space.

8. The information processing apparatus according to 6 or 7, wherein

the estimation means

determines that the effect is large in a case where a reaction of the avatar is favorable in a state in which the object exists in the field of view of the user or the avatar, and determines that the effect is small in a case where the reaction of the avatar is negative in the state.

9. The information processing apparatus according to any one of 1 to 8 above, wherein

the acquisition means further acquires at least part of operation information for the user to operate the avatar, the operation information being transmitted from the communication apparatus to the server, and

the estimation means further uses the at least part of the operation information in a case of estimating the effect.

10. The information processing apparatus according to any one of 1 to 9 above, wherein

the object includes an advertisement.

11. An information processing method including, by a computer:

acquiring field-of-view information that is information transmitted from a server to a communication apparatus to provide a service regarding a virtual space to a user, the field-of-view information being capable of estimating an object included in a field of view of the user or an avatar in the virtual space; and

estimating an effect of the object on the user by using the field-of-view information.

12. A program causing a computer to implement:

an acquisition means for acquiring field-of-view information that is information transmitted from a server to a communication apparatus to provide a service regarding a virtual space to a user, the field-of-view information being capable of estimating an object included in a field of view of the user or an avatar in the virtual space; and

an estimation means for estimating an effect of the object on the user by using the field-of-view information.

13. A recording medium in which the program according to 12 is recorded.

Some or all of the configurations described in Supplementary Notes 2 to 10 dependent on the above-described Supplementary Note 1 can also be dependent on Supplementary Notes 11, 12, and 13 by the same dependency relationship as in Supplementary Notes 2 to 10. Furthermore, not limited to Supplementary Notes 1, 11, 12, and 13, some or all of the configurations described as Supplementary Notes can similarly be made dependent, within a range not departing from the above-described example embodiments, on various hardware, software, various recording means for recording software, or systems.

1. An information processing apparatus comprising:
at least one memory storing instructions; and
at least one processor configured to execute the instructions to perform operations comprising:
acquiring field-of-view information that is information transmitted from a server to a communication apparatus to provide a service regarding a virtual space to a user, the field-of-view information being capable of estimating an object included in a field of view of the user or an avatar in the virtual space; and
estimating an effect of the object on the user by using the field-of-view information.

2. The information processing apparatus according to claim 1, wherein
the field-of-view information includes at least one of a coordinate and an orientation of the object in the virtual space and at least one of a coordinate and an orientation of the avatar in the virtual space.

3. The information processing apparatus according to claim 2, wherein
the field-of-view information includes both a coordinate and an orientation of the object, and both a coordinate and an orientation of the avatar.

4. The information processing apparatus according to claim 1, wherein
the field-of-view information includes a screen displayed on the communication apparatus.

5. The information processing apparatus according to claim 1, wherein
acquiring field-of-view information comprises acquiring the field-of-view information from a relay apparatus located between the server and the communication apparatus in a communication path.

6. The information processing apparatus according to claim 1, wherein
estimating an effect of the object comprises further using reaction information indicating a reaction of the user to the object to estimate the effect.

7. The information processing apparatus according to claim 6, wherein
estimating an effect of the object comprises generating the reaction information using behavior information indicating an action of the avatar in the virtual space.

8. The information processing apparatus according to claim 6, wherein
estimating an effect of the object comprises determining that the effect is large in a case where a reaction of the avatar is favorable in a state in which the object exists in the field of view of the user or the avatar, and determining that the effect is small in a case where the reaction of the avatar is negative in the state.

9. The information processing apparatus according to claim 1, wherein
acquiring field-of-view information comprises further acquiring at least part of operation information for the user to operate the avatar, the operation information being transmitted from the communication apparatus to the server, and
estimating an effect of the object comprises further using the at least part of the operation information to estimate the effect.

10. The information processing apparatus according to claim 1, wherein
the object includes an advertisement.

11. An information processing method comprising, by a computer:
acquiring field-of-view information that is information transmitted from a server to a communication apparatus to provide a service regarding a virtual space to a user, the field-of-view information being capable of estimating an object included in a field of view of the user or an avatar in the virtual space; and
estimating an effect of the object on the user by using the field-of-view information.

12. The information processing method according to claim 11, wherein
the field-of-view information includes at least one of a coordinate and an orientation of the object in the virtual space and at least one of a coordinate and an orientation of the avatar in the virtual space.

13. The information processing method according to claim 12, wherein
the field-of-view information includes both a coordinate and an orientation of the object, and both a coordinate and an orientation of the avatar.

14. The information processing method according to claim 11, wherein
the field-of-view information includes a screen displayed on the communication apparatus.

15. The information processing method according to claim 11, wherein
acquiring field-of-view information comprises acquiring the field-of-view information from a relay apparatus located between the server and the communication apparatus in a communication path.

16. The information processing method according to claim 11, wherein
estimating an effect of the object comprises further using reaction information indicating a reaction of the user to the object to estimate the effect.

17. The information processing method according to claim 16, wherein
estimating an effect of the object comprises generating the reaction information using behavior information indicating an action of the avatar in the virtual space.

18. The information processing method according to claim 16, wherein
estimating an effect of the object comprises determining that the effect is large in a case where a reaction of the avatar is favorable in a state in which the object exists in the field of view of the user or the avatar, and determining that the effect is small in a case where the reaction of the avatar is negative in the state.

19. The information processing method according to claim 11, wherein
acquiring field-of-view information comprises further acquiring at least part of operation information for the user to operate the avatar, the operation information being transmitted from the communication apparatus to the server, and
estimating an effect of the object comprises further using the at least part of the operation information to estimate the effect.

20. A non-transitory computer-readable medium storing a program causing a computer to perform operations comprising:
acquiring field-of-view information that is information transmitted from a server to a communication apparatus to provide a service regarding a virtual space to a user, the field-of-view information being capable of estimating an object included in a field of view of the user or an avatar in the virtual space; and
estimating an effect of the object on the user by using the field-of-view information.
